(19) United States
(12) Patent Application Publication
(10) Pub. No.: US 2008/0098147 A1
(43) Pub. Date: Apr. 24, 2008

(54) Bus repeater

(75) Inventor: Shigeru Amano, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 11/905,005

(22) Filed: Sep. 27, 2007

(30) Foreign Application Priority Data
Oct. 24, 2006 (JP) 2006-288251

(51) Int. Cl. G06F 13/00

(52) U.S. Cl. 710/300

(57) ABSTRACT

A bus repeater lying within a demodulation IC performs a bus repeat operation after a repeat operation has been made effective, and terminates the repeat operation on an autonomous basis when a stop condition for each serial data is detected. During the repeater operation, control on the direction of data transfer of a master-side IIC bus and control on the direction of data transfer of a tuner-side IIC bus corresponding to a repeat destination are performed by a master-side IIC bus transaction while they are being synchronized with each other. Therefore, the CPU-side IIC bus and the tuner-side IIC bus seem to be through-connected as the flow of the serial data. Further, data transfer can be done only when the swapping of the data with the tuner side is needed.

### BACKGROUND OF THE INVENTION

The present invention relates to a bus repeater used in a broadcasting receiver or the like that needs interference measures to a bidirectional serial bus such as a two-wire type serial bus (called Inter IC BUS: hereinafter called “IIC bus”) for communications provided between integrated circuits (hereinafter called “IC”) and provided inside a device.

FIG. 2 is a schematic block diagram showing a receiving section of a conventional general broadcasting receiver.

The receiving section of the broadcasting receiver is a system that makes use of an IIC bus 1 comprised of two bidirectional control lines for serial data SDA and a serial clock SCL. The receiving section has one bus master (e.g., a central processing unit (hereinafter called “CPU”) 2), and a plurality of bus slaves (such as a tuner IC 4, a demodulation IC 5 and a decoder IC 6 connected to an antenna 3). Input/output (hereinafter called “I/O”) buffers 2a, 4a, 5a and 6a respectively provided in these CPU 2, tuner IC 4, demodulation IC 5 and decoder IC 6 are interconnected with one another via the IIC bus 1.

FIG. 3 is a diagram showing a data format of the IIC bus shown in FIG. 2.

The data format of the IIC bus 1 comprises, for example, 9-bit data (=8-bit data D7 through D0+1-bit acknowledge signal A) interposed between a start condition S and a stop condition P. FIG. 3 is a diagram showing a 1-byte data transfer format. However, in the case of data exceeding two bytes, the following byte data D7 through D0 and acknowledge signal A arrive after the acknowledge signal A, and thereafter, the stop condition P arrives.

In the case of a first-byte format of the IIC bus 1, the first byte on the IIC bus 1 normally comprises slave addresses of 7 bits (D7 through D1) for the bus slaves, and one bit (D) indicative of write/read for the bus slaves having the slave addresses.

When D0 bit=“0” here, each succeeding byte indicates write for each bus slave. When D0 bit=“1”, the succeeding byte indicates read for the bus salve. In the case of each format subsequent to a second byte, of the IIC bus 1, D7 through D0 are 1-byte data to be transferred.

As the state of the IIC bus 1, the following states (1) through (4) are brought about.

(1) Idle State of IIC Bus

When the IIC bus 1 is in an idle state, both serial data SDA and serial clock SCL are respectively an “H” level.

(2) Start of IIC Bus Communication (Start Condition S)

The bus communication is started from the falling edge of the serial data SDA when the serial clock SCL is of the “H” level.

(3) End of IIC Bus Communication (Stop Condition P)

The bus communication is terminated on the rising edge of the serial data SDA when the serial clock SCL is of the “H” level.

(4) Transfer of Serial Data (Sampling Timing of Serial Data)

The receiving side fetches serial data SDA on the falling edge of the serial clock SCL one bit by one bit. The serial data SDA is sent out from the most significant bit (hereinafter called “MSB”) D7 and comprises one serial data of 8 bits. One bit following the 8-bit serial data is surely added with an acknowledge (A) bit and used in handshaking (swapping of a demand signal (request signal) and a response signal (acknowledge signal A)) of serial communications between the bus master and its corresponding bus slave.

The operation of the receiving section shown in FIG. 2 will next be described.

A physical channel is selected out of a digital terrestrial wave Sin inputted from the antenna 30 by the tuner IC 40. This is analog/digital (hereinafter called “A/D”)-converted so that a digital baseband signal S4 is outputted. The digital baseband signal S4 is fast Fourier-transformed (hereinafter called “FFT-transformed”) and orthogonal frequency division multiplex (hereinafter called “OFDM”)-modulated at the demodulation IC 5 to thereby generate a stream signal S5. The stream signal S5 is converted (decoded) into an image signal by the decoder IC 6. This is digital/analog (hereinafter called “D/A”)-converted so that an analog video signal Sout is outputted, followed by being supplied to speakers, earphones, a display (display device) and the like.

At this type of receiving section, the tuner IC 4 needs to be able to receive a small input signal from the antenna 3 and restore information as sent from a transmitting source. Therefore, it is necessary to remove the influence of interference on the tuner IC 4 from the IIC bus 1 during reception. As measures to it, the following contrivances of (a) through (c), for example, have been made.

(a) A signal line extending from the antenna 3, an I/O buffer terminal 4a of the tuner IC 4, and the IIC bus 1 itself are located away from the tuner IC 4.

(b) The tuner IC 4 is blocked off by a shield plate.

(c) A low-pass filter (hereinafter called “LPF”) is added to the IIC bus 1.

However, such measures are not enough and will cause demerits in terms of characteristics and cost.

Normally, the access (channel selection) to the tuner IC 4 does not occur during the progress of reception. If any, the tuner IC 4 is accessed to make a transition from a reception state to another state. Therefore, there is a possibility that although the time of access to the tuner IC 4 presents no problem but the time of access other than the above will not be affected during reception and by interference.

Thus, in order to solve such a problem, the techniques of bus repeaters described in patent documents (Japanese Unexamined Patent Publication No. 2000-174765 and Japanese Unexamined Patent Publication No. 2000-207072).

At the receiving section of FIG. 2, there is considered, for example, such a configuration that the tuner IC 4 and the IIC bus 1 are separated from each other, an unillustrated stack register (hereinafter given reference numeral “5b” for convenience) having a bus repeater function is provided in place of the I/O buffer 5a lying within the demodulation IC 5 and connected to the IIC bus 1, and the stack register 5b is connected to the tuner IC 4 via a newly added IIC bus 7.

In such a configuration, data to be written from the CPU 2 to the tuner IC 4 is stored temporarily stored in the stack register 5b lying in the demodulation IC 5. A data storage structure of the stack register 5b may have single information or full or all information of the tuner IC 4 corresponding to the repeat destination. The write data stored in the stack register 5b is sent to the tuner IC 4 via the IIC bus 7 and written into the tuner IC 4.

When the CPU 2 reads the data of the tuner IC 4 corresponding to the repeat destination, the CPU 2 requires the stack register 5b to make a read request to the repeat destination in advance. The data of the tuner IC 4 is read into the stack register 5b via the IIC bus 7 according to this request. After the completion of its reading, the data read into the stack register 5b is transmitted to the CPU 2 via the IIC bus 1.

According to such a configuration, since the tuner IC 4 is separated from the IIC bus 1, the tuner IC 4 does not suffer needless interference from the IIC bus 1.

However, such a configuration that the stack register 5b having the bus repeater function is provided involves the following problems.

The transfer is temporarily completed by the CPU 2 and the stack register 5b. Therefore, the transfer of a transfer status (acknowledge signal A/not-acknowledge signal NA) at the time that a problem has occurred in the transfer of data between the stack register 5b and the tuber IC 4 corresponding to the repeat destination, cannot be confirmed again unless a register indicative of the transfer status between the CPU 2 and the tuner IC 4 from the CPU 2 should be read. Therefore, it is not possible to confirm or recognize whether the transfer from the CPU 2 has been properly done, during its transfer. It is necessary to additionally confirm the transfer status between the CPU 2 and the tuner IC 4 corresponding to the repeat destination, thus increasing in complexity even on an operation processing (flow) basis. Besides, it is necessary to set to which extent retransmission should be performed by the stack register 5b and the tuner IC 4 corresponding to the repeat destination, for example. Thus, the operation processing is brought into very complication.

When the data storage structure of the stack register 5b is brought to the single information, the transfer status should be confirmed on an as-needed basis. Hence, it is very bad in efficiency. On the other hand, when the data storage structure has the stack register 5b corresponding to the full information, the stack register 5b needs huge or enormous capacity where the amount of information of the tuner IC 4 corresponding to the repeat destination is large.

### SUMMARY OF THE INVENTION

The present invention has been made in view of the foregoing. It is an object of the present invention to provide a bus repeater whose bus repeat operation processing is simplified and whose circuit is realized in simple form.

According to one aspect of the present invention, for attaining the above object, there is provided a bus repeater suitable for use in a system including a bus master and a first bus slave both connected to a bidirectional first serial bus, and a second bus slave connected to the first bus slave via a bidirectional second serial bus corresponding to a repeat destination, the bus repeater being provided in the first bus slave and performs a transfer of data between the first serial bus and the second serial bus corresponding to the repeat destination. Further, the bus repeater has the function of making effective a repeat operation in accordance with instructions given by the bus master and thereafter performing a bus repeat operation for transferring data between the bus master and the second bus slave, and terminating the bus repeat operation when a data transfer stop instruction is received from the bus master.

According to the present invention, such a circuit that a first serial bus and a second serial bus seem to be through-connected as the flow of serial data, and that is capable of transferring data only when the swapping of data with a second bus slave side is needed can be realized in simple form.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIGS. 1A and 1B are schematic block diagrams of a receiving section of a broadcasting receiver, showing a first embodiment of the present invention;

FIG. 2 is a schematic block diagram illustrating a receiving section of a conventional general broadcasting receiver;

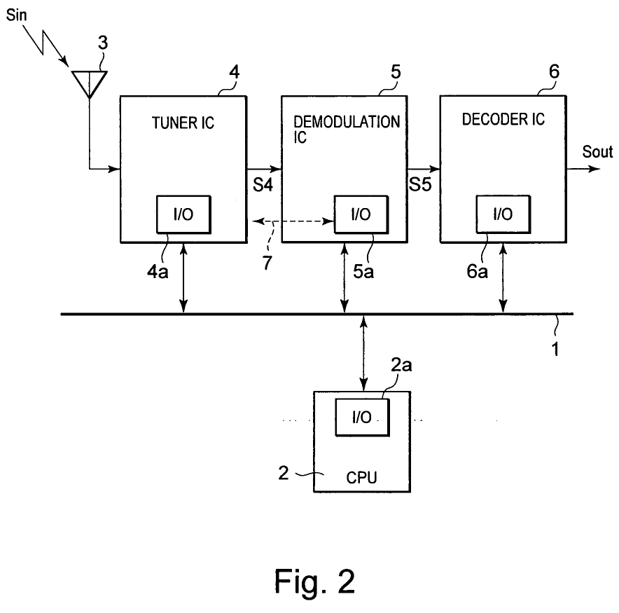

FIG. 3 is a diagram illustrating a data format of an IIC bus 1 shown in FIG. 2;

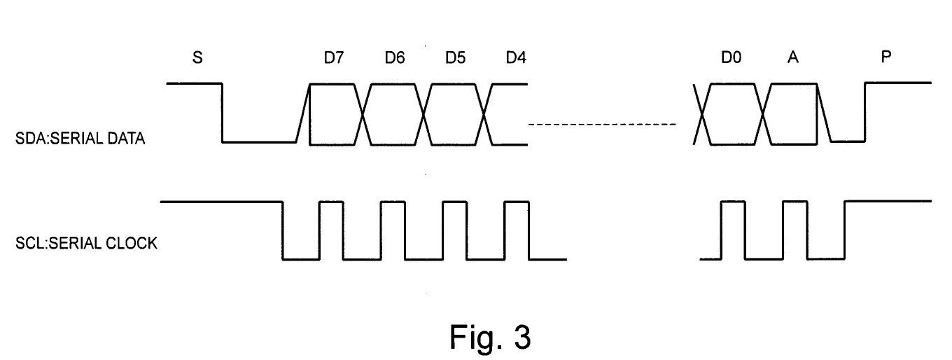

FIG. 4 is a time chart showing a data transfer example 1 of a bus repeat operation of FIG. 1;

FIG. 5 is a time chart illustrating a data transfer example 2 of the bus repeat operation of FIG. 1;

FIG. 6 is a schematic block diagram of the neighborhood of a bus repeater lying in a demodulation IC in a receiving section of a broadcasting receiver, showing a second embodiment of the present invention; and

FIG. 7 is a time chart illustrating a data transfer example of a bus repeat operation of FIG. 6.

### DETAILED DESCRIPTION OF THE PREFERRED EMBODIMENTS

A bus repeater performs a bus repeat operation after a repeat operation has been made effective. When a stop condition is detected, the bus repeater terminates the repeat operation on an autonomous basis. During the repeater operation, control on the direction of data transfer of a master-side IIC bus and control on the direction of data transfer of an IIC bus corresponding to a repeat destination are executed while they are being synchronized with each other.

Preferred embodiments of the present invention will hereinafter be described with reference to the accompanying drawings.

### First Preferred Embodiment

### (Configuration of First Embodiment)

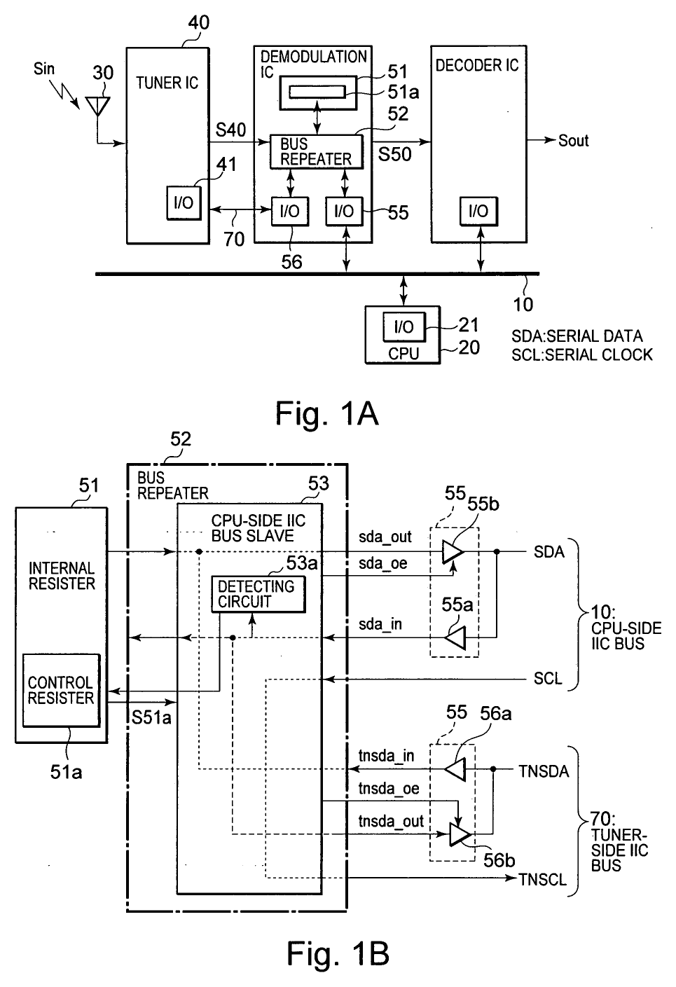

FIGS. 1(a) and 1(b) are schematic block diagrams of a receiving section of a broadcasting receiver, showing a first embodiment of the present invention, wherein FIG. 1(a) is a configuration diagram of the overall receiving section, and FIG. 1(b) is a configuration diagram of the neighborhood of a bus repeater lying in a demodulation IC.

The receiving section of the broadcasting receiver is of a system that makes use of a bidirectional first serial bus (IIC bus 10, for example) and includes one bus master (CPU 20, for example) and a plurality of bus slaves (e.g., a tuner IC 40 corresponding to a second bus slave used as a repeat destination connected to an antenna 30, a demodulation IC 50 corresponding to a first bus slave, and a decoder IC 60). These CPU 20, demodulation IC 50 and decoder IC 60 are interconnected with one another via the IIC bus 10. The tuber IC 40 and the demodulation IC 50 are interconnected with each other by a second serial bus (IIC bus 70, for example) corresponding to a repeat destination.

The CPU 20 is of a device which program-controls the overall receiving section. An I/O buffer 21 lying in the device is connected to the IIC bus 10. The tuner IC 40 is constituted of a high frequency (hereinafter called “RF”) IC, which is a circuit that selects a physical channel from a digital terrestrial wave Sin received by the antenna 30 and A/D-converts it, followed by the output of a digital baseband signal S40. An I/O buffer 56 lying within the demodulation IC 50 is connected to its corresponding I/O buffer 41 provided within this circuit via the IIC bus 70.

The demodulation IC 50 is a circuit that demodulates the digital baseband signal S40 by FFT conversion and thereby outputs a stream signal S50 therefrom. The demodulation IC 50 is constituted of an unillustrated demodulator circuit main body or unit, an internal register 51 having a control register 51a, a bus repeater 52 controlled by the internal register 51 or the like, and I/O buffers 55 and 56 or the like which perform the input/output of data from and to the bus repeater 52. The bus repeater 52 has a CPU-side IIC bus slave 53 or the like controlled by the internal register 51 or the like. A start/stop condition detecting circuit 53a and the like are provided within the IIC bus slave 53.

The CPU-side IIC bus slave 53 has the function of inputting a CPU-side serial clock SCL, serial data sda_in and tuner-side serial data tnsda_in therein to perform a bus repeat operation, based on a repeat operation control signal S51a supplied from the control register 51a and outputting a CPU-side output control signal sda_oe, serial data sda_out, a tuner-side serial clock TNSCL, an output control signal tnsda_oe and serial data tnsda_out. The start/stop condition detecting circuit 53a lying in the IIC bus slave 53 is a circuit which detects a start condition S or a stop condition P from the CPU-side serial data sda_in and supplies the thus-detected signal to the control register 51a.

The CPU-side I/O buffer 55 and the tuner-side I/O buffer 56 are connected to the bus repeater 52. The I/O buffer 55 comprises an input buffer 55a which inputs serial data SDA on the CPU side therein and supplies the corresponding serial data sda_in to the IIC bus slave 53, and a tri-state type output buffer 55b which is brought to an on state when the output control signal sda_oe is “0” and brought to an off state when it is “1” and which inputs the serial data sda_out therein and outputs the corresponding serial data SDA to the CPU-side IIC bus 10 when it is in the on state. The I/O buffer 56 comprises an input buffer 56a which inputs tuner-side serial data TNSDA therein and supplies the corresponding serial data tnsda_in to the IIC bus slave 53, and a tri-state type output buffer 56b which is brought to an on state when the output control signal tnsda_oe is “0” and brought to an off state when it is “1” and which inputs the serial data tnsda_out therein and outputs the corresponding serial data TNSDA to the tuner-side IIC bus 70 when it is in the on state.

The decoder IC 60 is connected to the demodulation IC 50. The decoder IC 60 is a circuit which decodes the stream signal S50 according to an MPEG2 (Moving Picture Experts Group phase 2) system to generate a digital video signal and D/A-converts it to output an analog video signal Sout, followed by the supply thereof to speakers, earphones, a display device and the like. An I/O buffer 61 lying within this circuit is connected to the IIC bus 10.

### (Overall Operation of First Embodiment)

A physical channel is selected from a digital terrestrial wave Sin inputted from the antenna 30 by the tuner IC 40 under the control of the CPU 20. This is A/D-converted so that a digital baseband signal S40 is outputted. The digital baseband signal S40 is FFT-transformed and OFDM-modulated at the demodulator circuit main body lying within the demodulation IC 50 to generate a stream signal S50. The stream signal S50 is converted (decoded) into an image signal by the decoder IC 60. This is D/A-converted so that an analog video signal Sout is outputted, followed by being supplied to the speakers, earphones, display device and the like.

### (Data Transfer Example 1 of Bus Repeat Operation of First Embodiment).

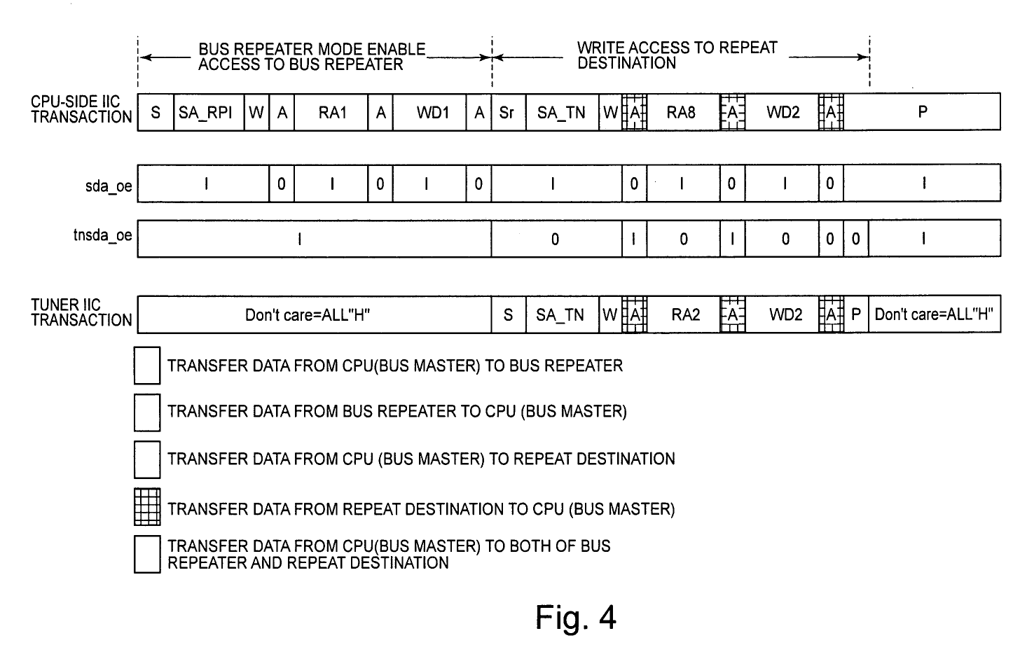

FIG. 4 is a time chart showing a data transfer example 1 of the bus repeat operation of FIG. 1.

Shown in the present time chart are a start condition S for serial data SDA, a slave address SA_RPT to the bus repeater 52, a write request signal W from the CPU 20 corresponding to the bus master, an acknowledge signal A indicative of a transfer status, register addresses RA1 and RA2 of the internal register 51, write data WD1 and WD2, a restart condition Sr for serial data SDA, a slave address SA_TN to the tuner IC 40 corresponding to the repeat destination, and a stop condition P for the serial data SDA.

When a serial clock SCL and bidirectional serial data SDA are supplied from the CPU-side IIC bus 10 under the control of the CPU 20 in the demodulation IC 50 shown in FIG. 1, the serial clock SCL is inputted to the CPU-side IIC bus slave 53 and the serial data SDA is taken or fetched in the input buffer 55a. The fetched serial data sda_in is inputted to the CPU-side IIC bus slave 53. When an output control signal sda_oe and serial data sda_out are outputted from the CPU-side IIC bus slave 53 under the control of the CPU 20, the output buffer 55b is brought to an on state when the output control signal sda_out is “0”, and the serial data sda_out is driven by the output buffer 55b, followed by being outputted to the CPU-side IIC bus 10.

When a serial clock TNSCL, an output control signal tnsda_oe and bidirectional serial data tnsda_out are outputted from the CPU-side IIC bus slave 53 in accordance with the control of the CPU 20, the serial clock TNSCL is outputted to the tuner-side IIC bus 70. Further, when the output control signal tnsda_oe is “0”, the output buffer 56b is brought to an on state, so that the serial data tnsda_out is driven by the output buffer 56b. Thus, the so-driven serial data TNDSA is outputted to the tuner-side IIC bus 70. When the serial data TNSDA is supplied from the tuner-side IIC bus 70 in accordance with the control of the CPU 20, the serial data TNSDA is fetched into the input buffer 56a, and the thus-fetched serial data tnsda_in is inputted to the CPU-side IIC bus slave 53.

Upon access from the CPU 20 to the bus repeater 52 (upon bus repeater mode enable access to the bus repeater 52) as a basic operation of the data transfer example 1, the start/stop condition detecting circuit 53a provided in the CPU-side IIC bus slave 53 determines or judges it and converts it to access to the inside.

Upon an access request (write access to the repeat destination) to the tuner IC 40 of the repeat destination by the CPU 20, access after the CPU 20 instructed the bus repeater 52 to carry out the access to the tuner IC 40 corresponding to the repeat destination is transferred to the tuner-side IIC bus 70 as it is. Such an operation that the transfer thereof to the tuner IC 40 corresponding to the repeat destination is continued until, for example, a stop condition P for serial data SDA and TNSDA is generated, and its transfer is released or canceled by detection of the stop condition by the start/stop condition detecting circuit 53a, can be controlled.

Upon execution of the repeat operation, the bus repeater 52 simply performs switching between the transfer of data from the CPU-side IIC bus 10 to the tuner-side IIC bus 70 and the transfer of data from the tuner-side IIC bus 70 to the CPU-side IIC bus 10 according to the contents of IIC bus processing (CPU-side IIC bus transaction) from the CPU 20.

### (Data Transfer Example 2 of Bus Repeat Operation of First Embodiment)

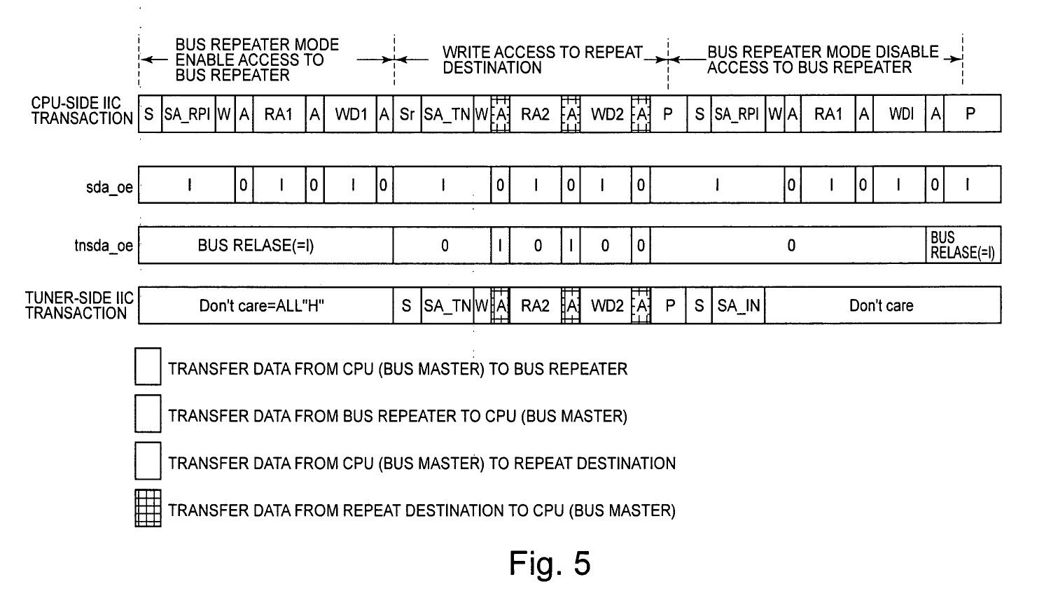

FIG. 5 is a time chart showing a data transfer example 2 of the bus repeat operation of FIG. 1. Constituent elements common to those in the time chart of FIG. 4 are respectively given common symbols.

Upon access from the CPU 20 to the bus repeater 52 (upon bus repeater mode enable access to the bus repeater 52) as a basic operation of the data transfer example 2, the start/stop condition detecting circuit 53a provided in the CPU-side IIC bus slave 53 determines or judges it and converts it to access to the inside in a manner similar to the data transfer example 1 of FIG. 4.

Upon an access request (write access to the repeat destination) to the tuner IC 40 of the repeat destination by the CPU 20, access after the CPU 20 instructed the bus repeater 52 to carry out the access to the tuner IC 40 corresponding to the repeat destination is transferred to the tuner-side IIC bus 70 as it is, in a manner similar to the data transfer example 1 of FIG. 4.

The data transfer example 2 is different from the data transfer example 1 of FIG. 4 in that a bus repeater mode disable access to the bus repeater 52 is added to stop the repeat operation of the bus repeater 52 after write access to the repeat destination in accordance with the control of the CPU 20 at a CPU-side IIC bus transaction and a tuner-side IIC bus transaction.

Thus, the transfer to the tuner IC 40 corresponding to the repeat destination is continued until, for example, a stop condition P for serial data SDA and TNSDA is generated, and a repeat operation control signal S51a outputted from the control register 51a provided within the internal register 51 is switched, whereby the presence or absence of the repeat operation can be controlled.

Upon execution of the repeat operation, the bus repeater 52 simply performs switching between the transfer of data from the CPU-side IIC bus 10 to the tuner-side IIC bus 70 and the transfer of data from the tuner-side IIC bus 70 to the CPU-side IIC bus 10 in a manner similar to the data transfer example 1 of FIG. 4.

### (Advantageous Effects of First Embodiment)

According to the bus repeat operation of the first embodiment, the bus repeat operation is performed after the repeat operation has been made effective, and the repeat operation is completed on an autonomous basis when the stop condition S is detected. During the repeater operation, control on the direction of data transfer of the master-side IIC bus 10 and control on the direction of data transfer of the tuner-side IIC bus 70 corresponding to the repeat destination are performed while they are being kept sync with each other.

Therefore, such a circuit that the CPU-side IIC bus 10 and the tuner-side IIC bus 70 seem to be through-connected as the flow of the serial data SDA and TNSDA and that is capable of transferring data only when the swapping of the data with the tuner side is needed can be realized in simple form.

### Second Preferred Embodiment

Since it is necessary that the CPU-side IIC bus 10 and the tuner-side IIC bus 70 coincide with each other perfectly in the first embodiment, the present embodiment is not applicable to a case in which they are different in transfer rate although these buses are coincident in type with each other, and a case in which they are different in the type per se. Therefore, the second embodiment will solve such a problem.

### (Configuration of Second Embodiment)

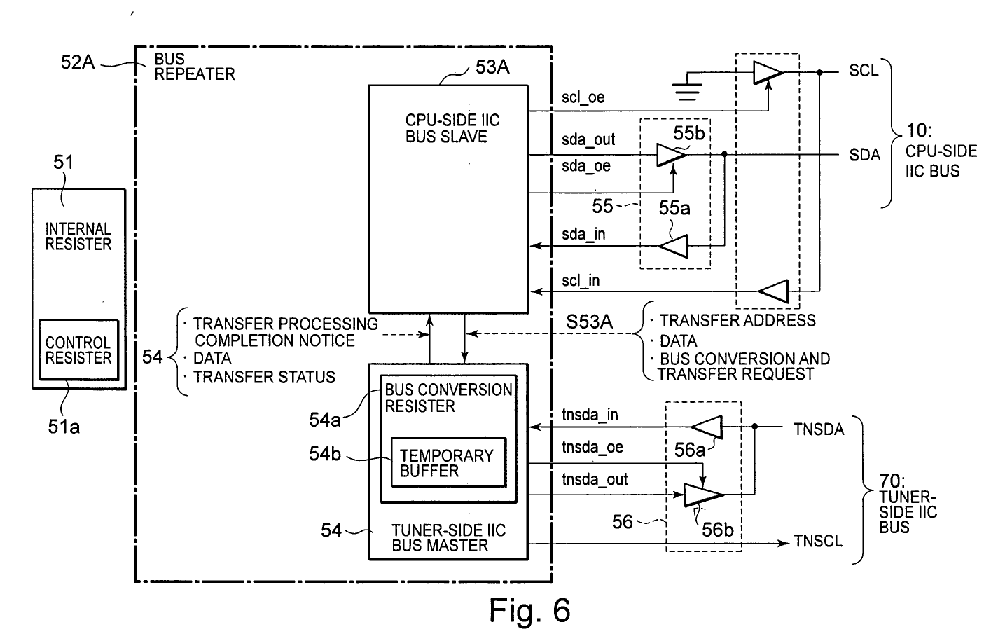

FIG. 6 is a schematic block diagram of the neighborhood of a bus repeater lying within a demodulation IC employed in a receiving section of a broadcasting receiver, showing the second embodiment of the present invention. Constituent elements common to those in FIG. 1(b) showing the first embodiment are respectively given common symbols.

The second embodiment is different from the first embodiment in terms of the configuration of the neighborhood of the bus repeater provided within the demodulation IC 50 shown in FIG. 1(a) of the first embodiment. That is, in the second embodiment, an internal register 51 similar to the first embodiment, a bus repeater 52A different in configuration from the bus repeater 52 of the first embodiment, I/O buffers 55 and 56 similar to those of the first embodiment and a newly-added I/O buffer 57 are provided in the demodulation IC 50 shown in FIG. 1(a).

The bus repeater 52A has a CPU-side IIC bus slave 53A different in configuration from the CPU-side IIC bus slave 53 of the first embodiment, and a newly-added tuner-side IIC bus master 54. These CPU-side IIC bus slave 53A and the tuner-side IIC bus master 54 are interconnected with each other.

The CPU-side IIC bus slave 53A is controlled by a repeat operation control signal or the like supplied from the internal register 51 to perform a bus repeat operation. The CPU-side IIC bus slave 53A has the function of inputting serial data sda_in supplied from the I/O buffer 55, a serial clock scl_in supplied from the I/O buffer 57, information (such as a transfer processing completion notice, data and transfer status (acknowledge signal A/not-acknowledge signal NA)) S54 supplied from the tuner-side IIC bus master 54, and outputting an output control signal sda_oe for the serial data, an output control signal scl_oe for the serial clock, serial data sda_out, and information (such as a transfer address, data and bus conversion/transfer request) S53A supplied to the tuner-side IIC bus master 54.

The tuner-side IIC bus master 54 has a bus converting bus conversion register 54a having a minimal temporary storage buffer 54b necessary for bus conversion, etc. The tuner-side IIC bus master 54 is controlled by a repeat operation control signal or the like supplied from the internal register 51 to perform a bus repeat operation. The tuner-side IIC bus master 54 has the function of inputting serial data tnsda_in supplied from the I/O buffer 56, and the information S53A supplied from the CPU-side IIC bus slave 53A and outputting a serial clock TNSCL, an output control signal tnsda_oe for the serial data, serial data tnsda_out, and the information S54 supplied to the CPU-side IIC bus slave 53A. Particularly, the bus conversion register 54a has the function of performing desired bus conversion on the information S53A supplied from the CPU-side IIC bus slave 53A and thereafter transferring it to the tuner-side IIC bus 70.

A CPU-side IIC bus 10 is connected to the CPU-side IIC bus slave 53A via the I/O buffers 55 and 57. The tuner-side IIC bus 70 is connected even to the tuner-side IIC bus master 54 via the I/O buffer 56. Further, the serial clock TNSCL outputted from the tuner-side IIC bus master 54 is supplied to the tuner-side IIC bus 70.

The I/O buffer 57 comprises an input buffer 57a which drives a serial clock SCL supplied from the CPU-side IIC bus 10 and inputs the thus-driven serial clock scl_in to the CPU-side bus slave 53A, and an output buffer 57b which is brought to an on state when the output control signal scl_oe outputted from the CPU-side IIC bus slave 53A is “0”, thereby to set the input side of the input buffer 57a to a ground potential (“L” level). The output control signal scl_oe outputted from the CPU-side IIC bus slave 53A is a signal which performs control for outputting “0” with respect to the serial clock SCL. This “0” output makes it possible to fix the serial clock SCL to the “L” level and hold the CPU-side IIC bus 10 (bring it to a busy state).

Other configurations are similar to those employed in the first embodiment. Incidentally, although the examples of the IIC buses are shown on both the CPU and tuner sides in FIG. 6, the type of bus on the tuner side is arbitrary.

### (Data Transfer Example of Bus Repeat Operation of Second Embodiment)

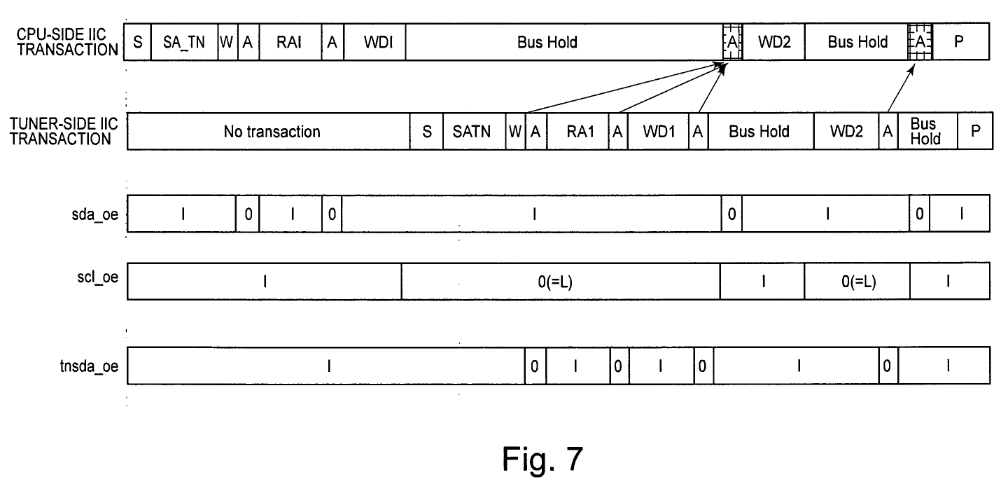

FIG. 7 is a time chart showing a data transfer example of the bus repeat operation of FIG. 6. Constituent elements common to those in the time chart of FIG. 4 are respectively given common symbols.

As a basic operation of the second embodiment, the CPU-side IIC bus slave 53A requires its accepted transfer request of the tuner-side IIC bus master 54 at a CPU-side IIC bus transaction and a tuner-side IIC bus transaction. The CPU-side IIC bus 10 assumes or takes Bus Hold until its processing is completed by a predetermined portion. When its processing is completed to that extent, a transfer status (acknowledge signal A/non-acknowledge signal NA) is answered to resume the setting of the CPU-side IIC bus 10 to a ready state. This is repeated to complete the transfer.

### (Advantageous Effects of Second Embodiment)

According to the bus repeat operation of the second embodiment, in order to return the transfer status to the master-side IIC bus 10 during transfer, the CPU-side IIC bus 10 is taken hold while the data transfer to the tuner-side IIC bus 70 corresponding to the repeat destination is being performed, thereby performing the transfer. When the transfer status is obtained, the CPU-side IIC bus 10 is restored and a status obtained thereat is returned to the tuner-side IIC bus 70. Further, when a transfer request is made, the tuner-side IIC bus 70 corresponding to the repeat destination is taken hold. When a request is issued, the tuner-side IIC bus 70 is restored to carry out transfer.

Thus, since the transfer status on the tuner side during the period in which the CPU-side IIC bus 10 is being taken hold, is returned with being superimposed on the held CPU-side IIC bus transaction while the CPU-side IIC bus 10 is being taken hold, the CPU-side IIC bus 10 and the tuner-side IIC bus 70 seem to be directly connected to each other as the flow of the serial data SDA and TNSDA. Further, data can be transferred only when the swapping of the data with the tuner side is needed, and transfer with bus conversion can also be performed.

### Preferred Modified Examples

The present invention is not limited to the first and second embodiments. Various use forms and modifications can be made. For instance, the bus repeaters 52 and 52A of FIGS. 1 and 6 provided within the demodulation IC 50 shown in FIG. 1 may be changed to other configurations other than illustrated in the drawings. The first and second embodiments are not applied to the broadcasting receiver alone, and the tuner IC 40 portion is widely applicable as RFIC.

The present invention is not limited to broadcasting devices and IIC buses but applicable to general apparatuses that need to take interference measures to a serial bus.

While the preferred forms of the present invention have been described, it is to be understood that modifications will be apparent to those skilled in the art without departing from the spirit of the invention. The scope of the invention is to be determined solely by the following claims.

1. A bus repeater suitable for use in a system including a bus master and a first bus slave both connected to a bidirectional first serial bus, and a second bus slave connected to the first bus slave via a bidirectional second serial bus corresponding to a repeat destination,
said bus repeater being provided in the first bus slave and performs a transfer of data between the first serial bus and the second serial bus corresponding to the repeat destination, and
said bus repeater having the function of making effective a repeat operation in accordance with instructions given by the bus master and thereafter performing a bus repeat operation for transferring data between the bus master and the second bus slave, and terminating the bus repeat operation when a data transfer stop instruction is received from the bus master.

2. The bus repeater according to claim 1, having the function of performing data transfer direction control of the first serial bus and data transfer direction control of the second serial bus corresponding to the repeat destination in accordance with instructions issued from the bus master during the bus repeat operation while both are being synchronized with each other.

3. The bus repeater according to claim 1, further having the function of holding the first serial bus while the transfer of data to the second serial bus corresponding to the repeat destination is being performed, restoring the first serial bus when a transfer status at the data transfer is obtained and returning the transfer status to the first serial bus.

4. The bus repeater according to claim 1, further having the function of holding the second serial bus when a transfer request to the second serial bus corresponding to the repeat destination is made, restoring the second serial bus when the transfer request is made, and performing the data transfer.
